(19) United States
(12) Patent Application Publication
(10) Pub. No.: US 2004/0115511 A1
(43) Pub. Date: Jun. 17, 2004

(54) End-plate assembly of an electrochemical cell with a polymer elctrolyte membrane construction

(76) Inventors: Stefan Holler, Lubeck (DE); Uwe Kuter, Lubeck (DE)

Correspondence Address: Jacox Meckstroth & Jenkins, 2310 Far Hills Building, Dayton, OH, 45419-1575, US

(21) Appl. No.: 10/472,616

(22) PCT Filed: Mar. 22, 2002
(86) PCT No.: PCT/DE02/01060

(30) Foreign Application Priority Data
Mar. 24, 2001 (EP) 01107354.1

(51) Int. Cl. H01M 8/02; H01M 8/04; H01M 8/10

(52) U.S. Cl. 429/37; 429/34; 429/32; 429/25

(57) ABSTRACT

The end-plate assembly clamps an electrochemical cell or a stack of electrochemical cells with a polymer electrolyte membrane construction, in addition to forming the contact. An end plate (1) consisting of a synthetic material or metal, which is used to introduce the compressive forces into the cells or the cell stack, is provided. The end plate (1) is provided with a compensation layer (5) in the vicinity of the cell, which evens out the force introduction into the cell or the stack over the surface. The compensation layer (5) is covered with an electrically conductive layer (6), in order to form the electric connection (7) to the cell. The electrically conductive layer (6) is coupled to a connection (7) that is externally accessible. The compensation layer is formed by a material that is free-flowing under pressure, in such a way that it can be manipulated like a solid or pasty material during assembly, but takes on substantially liquid and thus excellent pressure distribution properties after the application of the clamping forces to the cell stack.

### BACKGROUND OF THE INVENTION

The invention relates to an end-plate assembly of an electrochemical cell of the polymer electrolyte membrane construction type, in particular a cell stack with in particular edge-side tensioning between two end-plates.

Electrochemical cells of the polymer electrolyte membrane construction type are known and for example described in DE 195 44 323 A1. Such cells may either be applied as a fuel cell, i.e. for production of electricity from fuel and oxygen, but also be applied as an electrolyzer in order to obtain hydrogen and oxygen from water whilst applying current. As a rule, in its practical application a multitude of electrochemical cells are applied in a stack assembly, as this for example is known from WO 99/28985 and here in particular is known from FIG. 1. At the same time one constantly strives to configure the construction as compactly as possible in order to achieve a high energy density with a small constructional size, and to achieve as low as possible weight. A further object as always is to reduce the manufacturing costs.

The electrochemical cell consists essentially of a polymer electrolyte membrane, i.e. an ion-permeable film which on both sides is covered by a gas diffusion electrode which brings the catalytically effective layer onto the membrane. The gas diffusion electrodes in each case are covered with a bipolar plate via which the supply and removal of fuel and oxygen is effected. A gas diffusion electrode with a polymer electrolyte membrane in turn connects to such a bipolar plate on the other side, etc. At both ends of such a stack of electrochemical cells there is usually provided an end-plate via which the electrical power is fed and led away and via which the pressure forces are introduced into the cell stack which are required for the effective operation of this. For this the end-plates on the edge side usually comprise recesses through which tension rods are led, which clamp the two end-plates amid the inclusion of the cell stack lying between these. So that the pressing pressure within the cells is as constant as possible over the surface, it is necessary to introduce these tensile forces into the stack over the surface as uniformly as possible. For this reason the end-plates are regularly manufactured of solid metal in order to achieve as little as possible sagging over the surface and thus to achieve a uniform pressing pressure. Thus end-plates of a known cell stack with surface areas for example of 20 cm² are typically 1 cm thick. Such end-plates increase the height of the cell stack, they are heavy and are furthermore expensive in manufacture.

In order to achieve a uniforming of the pressing pressure and thus also a reduction of the end-plate thickness, it is already known to provide an elastic compensation layer between the end-plate and cell stack (U.S. Pat. No. 5,547,777). This known elastic compensation layer however only insufficiently solves the previously mentioned problem. As far as this is concerned the solution known from DE 100 03 528 A1 is more favorable, with which a fluid forms the compensation layer. Here the pressing pressure is distributed completely uniformly over the surface area. However the disadvantage is the high construction expense and particularly the assembly expense since the fluid may only be filled after the assembly has been completely assembled and after the chamber accommodating the fluid has been hermetically sealed.

### BRIEF SUMMARY OF THE INVENTION

Against this background it is the object of the invention to improve an end-plate assembly of the known type to the extent that the pressing pressure distribution is made uniform over the surface area, but that the construction expense and in particular the assembly expense is reduced.

The features specified in claim 1 achieve this object. Advantageous formations of the invention are specified in the dependent claims of the subsequent description as well as the drawing.

The basic concept of the present invention is to provide a compensation layer which has the favorable pressure distribution properties of a fluid, but to reduce the construction expense in that with the incorporation of this compensation layer one preferably uses a solid, at least pasty substance, thus one does not need to take any particular measures with regard to any sealing with respect to a fluid. Accordingly as a compensation substance the invention envisages a substance which is free-flowing under pressure. A substance free-flowing under pressure in the context of the invention is to be understood as a substance which on assembly is solid or pasty but which on applying the clamping force between the end-plates, on account of the pressure which then prevails, behaves essentially as a fluid with regard to the pressure distribution, i.e. distributes the pressure uniformly over the adjacent surfaces areas, in particular also over the pressing surface facing the cell stack.

A substance free-flowing under pressure may for example be an adhesive film between the electrically conductive layer and the end-plate which has a flow property above a certain pressure so that the desired evening-out effect is effected with an increasing introduction of force on assembly of the stack, in particular on tightening the tension rods.

The invention thus unifies the advantages of a free-flowing compensation layer with those of a solid compensation layer. Advantageously an adhesive film is applied as a compensation layer, which on account of the adhesive properties is not only particularly well fixable between the end-plate and the electrically conductive layer but furthermore has the advantage that on assembly it fixes the electrically conductive layer on the end-plate. Alternatively one may also apply a pasty substance, for example silicon. At the same time it is of no significance if the silicon, as is usually the case for example with usual sealing substances based on silicon, superficially dries or cures during assembly. This procedure may however only occur to the extent that the flowability under pressure is still ensured.

The compensation layer may also be formed by a curing layer, for example a silicone layer, a lacquer or a multi-component epoxy resin, wherein the curing parameters are to be selected such that the curing of the whole compensation layer only occurs if the stack of electrochemical cells is completely assembled and impinged with pressure.

Preferably the compensation layer however is selected such that a complete curing at least under pressure is not effected so that the fluid properties for pressure distribution remain intact.

On application of pasty compensation layers which are particularly favorable with regard to evening out the force introduction, it is useful in the end-plate to provide a recess in which this layer may be applied. At the same time the layer to the one side is covered by the end-plate and to the other side by the electrically conductive layer which as a rule is formed by a metal plate or foil, and may only cure over a short term in narrow edge regions. This curing of the edge regions is desired, since only thus may it be ensured that medium which is then liquid does not escape through the edge gaps when introducing the pressure forces, but is held by the sections which have already been cured.

In order to ensure the electrical function of the end-plate arrangement, the compensation layer at the side facing the cell is provided with an electrically conductive layer which however has no carrying function. This electrically conductive layer comprises an electrical connection which is accessible from the outside and via which the electrical power is led away or supplied.

The electrically conductive layer is preferably formed by a thin metal plate or also with metal foil, preferably of copper or a copper alloy in order to achieve a high conductivity. Here for example one may select a 0.1 to 1 mm thick copper foil, wherein the thickness of the electrically conductive layer is determined to a great extent by electrical parameters.

Copper plates or foils although having a large conductivity are however relatively sensitive to corrosion. It is therefore useful to provide such a metal plate on the side facing the cell with a further electrically conductive, but corrosion-resistant layer. Such a layer may for example consist of gold.

With regard to the corrosion resistance a titanium layer in the form of a titanium film is sufficient and this is considerably more favorable than gold with regard to cost. Such a foil may be connected to the metal plate by way of an electrically conductive adhesive, e.g. an electrically conductive epoxy resin adhesive. A silver-containing epoxy resin adhesive has for example been shown to be favorable, with which the titanium foil may be adhered to the copper plate in a large-surfaced manner.

A metal foil which for improving the conductive properties or for retaining constant conductive properties is coated over the surface, and specifically on the side facing the cell preferably forms the electrically conductive layer. Such a metal foil may for example be a nickel, copper, silver or also other foil. The coating may be formed in the form of a precious metal or a precious metal alloy or also in the form of titanium nitride. The later substance has proven itself inasmuch as it has a great hardness and a high consistency of the conductive properties.

In order to ensure that the elastic layer does not laterally escape after applying the pressure, a hermetically sealed space must be formed between the end-plate and the electrically conductive layer or the cell stack lying therebehind. This space may laterally be formed for example by an edge which surrounds the compensation layer and is provided in the end-plate. If such an edge is not provided, on the edge side one may also provide an annular seal between the end-plate and the electrically conductive layer, which delimits this space. Such a seal may for example be designed in the form of a simple O-ring or also a punched seal of rubber or of another suitable material.

Due to the favorable pressure distribution of the end-plate onto the cell stack, then according to the invention the end-plate may be designed with less intrinsic stiffness and thus lighter in comparison to the state of the art. One may for example apply end-plates which are formed by plastic injection molded parts and which already comprise the edge-side recesses for the tension rods so that a retrospective machining of the end-plates is not required.

Although the contacting of the metallically conducting layer may basically be effected selectively from the side, or to the rear through the end-plate, the rearward contacting is particularly favorable since with this an essentially central contacting from the middle of the surface may be effected, with which due to the distribution of the flow of current in all directions, the dimensioning of the layer thickness may be effected much lower. The end-plate which is preferably manufactured as a plastic injection molded part in the edge regions comprises recesses for the tension rods as well as also a recess for contacting the metal plate in the case that a central leading-through of current is to be effected.

The dimensioning of the plastic plate must be effected such that it securely accommodates the force of the tension rods and may transmit this to the cell stack. A certain elastic deformation may however be tolerated here since this is compensated by the compensation layer.

The solution according to the invention may not only be applied to end-plate assemblies in combination with cell stacks as described previously, but may also be advantageously applied to an individual cell or also to a cell stack consisting of only two cells. In particular with a cell stack consisting of two or slightly more cells, the pressure compensation layer according to the invention may also be arranged between the cells, so that the neighboring cells in their shape are adapted to the end-plates which are curved by the tensile forces, wherein the pressure distribution is completely uniform over the surface due to the pressure compensation layer between the cells.

### BRIEF DESCRIPTION OF THE DRAWINGS

The invention is hereinafter explained by way of the embodiment examples shown in the drawing. There are shown in:

FIG. 1 a view of the end-plate assembly from the cell,

FIG. 2 a section, along the section line II-II in FIG. 1,

FIG. 3 a view of the rear side of the end-plate assembly,

FIG. 4 an end-plate with compensation layer, without force, in a schematic sectioned representation,

FIG. 5 the same assembly after impingement with force,

FIG. 6 a section according to FIG. 2 of a further embodiment variant, in section.

### DETAILED DESCRIPTION OF THE INVENTION

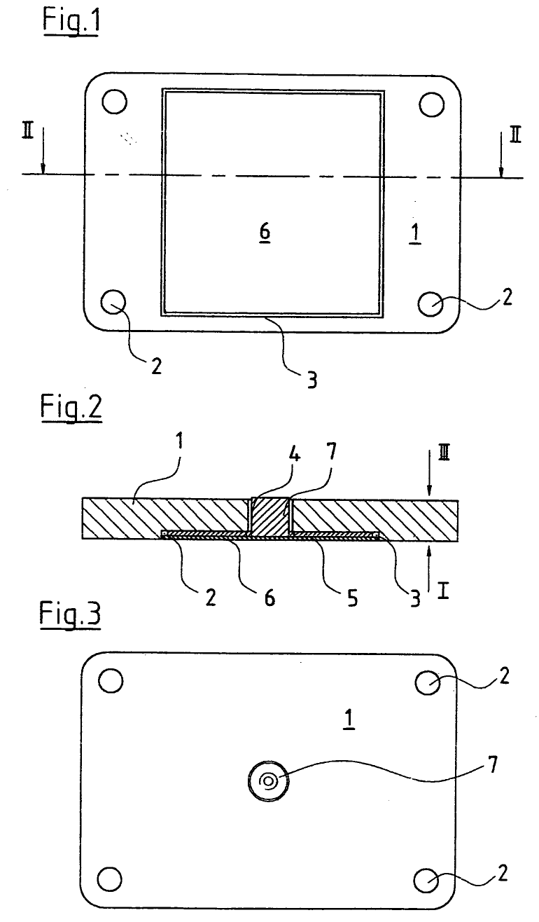

The end-plate assembly shown by way of the FIGS. 1 to 3 are applied in pairs and includes one or usefully more electrochemical cells of the polymer electrolyte membrane construction type arranged behind one another, as for example are described in DE 195 44 323 A1. In this document the construction of such a cell stack is for example described by way of FIG. 1 which herewith is referred to. The end-plate arrangement comprises an end-plate 1 of a rectangular shape which projects beyond the cell stack on all four sides. The end-plate 1 is formed as a plastic injection molded part, comprises four through-going recesses 2 in the comer regions as well as a flat square recess 3 in the side directed towards the cell. This flat recess 3 over the surface forms a deepening and is only through-going in the central region in the middle of the plate 1. This region is indicated at 4. The recess 3 with regard to area is dimensioned according to the size of the cell lying under it.

In the recess 3 lies a compensation layer 5 in the form of an elastic adhesive film as well as a metal plate 6 covering this, and this layer bears directly on the end-plate 1. The metal plate 6 lies in the recess with a slight lateral play, in contrast to which the compensation layer 5 has a significant play towards the edge of the recess 3, as may also be deduced from FIG. 2. The free space is formed by way of this which serves so that the material of the compensation layer 5 may laterally escape on force impingement.

The metal plate 6 on the rear side is provided with a cylindrical projection 7 which is connected to this in a rigid and conductive manner and which is led through the compensation layer 5 as well as through the central recess 4 in the end-plate 1 so that the metal plate 6 may be electrically contacted via this cylindrical projection 7.

The metal plate 6 consists of copper and is furnished on its side facing the cell with a titanium foil. Titanium foil is connected to the copper plate by way of an electrically conductive adhesive.

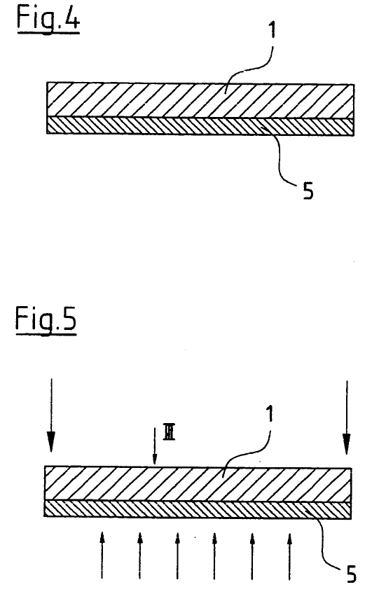

In the unloaded condition the end-plate 1 is designed plane-parallel (it has at least on its side facing the cell a plane surface), just as the compensation layer 5 (see FIG. 4) which bears on this. In the case of loading, if a cell stack is clamped between two end-plate assemblies according to the previously described manner and a tension rod led through the recesses 2, by way of the tension rod a pressure force of between 50 and 200 N/cm²is exerted with fuel cells and between 1000 and 4000 N/cm² with electrolyzers. This force is introduced in the region of the recesses 2 from the rear side III of the end-plates 1 so that the end-plate 1 is deformed as shown in FIG. 5. By way of the counter pressure of the cell stack the end-plate 1 is curved beyond this so that the side III facing outwards is deformed slightly convexly and the inner side on which the compensation layer 5 bears is deformed slightly concavely.

The compensation layer 5 is provided in order to prevent a non-uniform introduction of force into the cell stack lying thereunder, wherein this layer becomes thinner in the lateral regions than in the middle according to the non-uniform introduction of force over the end-plate 1. In the ideal case which in particular occurs if the compensation layer 5 has hydraulic properties, the non-uniform introduction of force is completely compensated by the end-plate 1 by way of the compensation layer 5.

The compensation layer 5 obtains the hydraulic properties by way of the compression forces exerted via the tension rods, which exert such a pressure onto this compensation layer 5 that this becomes free-flowing.

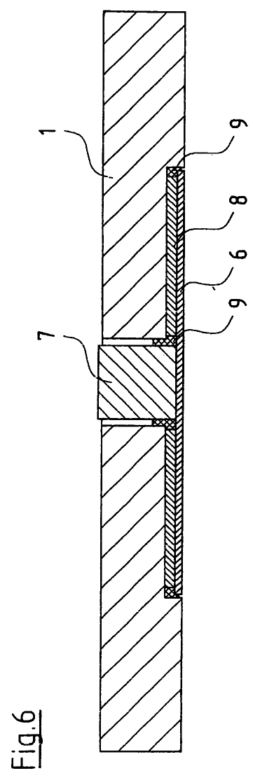

The end-plate assembly represented in FIG. 6 comprises the same end-plate 1 as that described previously, and the metal plate 6 is designed in the same manner. In contrast to the previously described embodiment variant however there is provided a compensation layer 8 of self-curing silicon.

This compensation layer 8 is incorporated into the recess 3 of the end-plate 1, whereupon the metal plate 6 is applied with its cylindrical projection 7. In this preassembled position the component remains for a certain time until in the edge regions between the central recess 4 and the projection 7 as well as laterally between the metal plate 6 and the recess 3 a cured region 9 sets in. These regions 9 are still highly elastic, but are cured so much that with a further introduction of force it is ensured that the liquid medium 8 under pressure which is not yet cured may not escape via the edge gaps. It is evident that such an assembly is particularly favorable since the compensation layer has hydraulic properties so that there is effected a particularly uniform distribution of force over the surface. If the cell stack then is assembled and the tension rods tightened, over a longer time, for example during operation, the compensation layer will completely cure which however is not a problem since the equilibrium of forces has already set it and the remaining residual elasticity of this layer is sufficient in order to compensate any stress peaks which may arise due to thermal influences.

With the metal layer indicated at 6 and described in the previous embodiment forms it is the case of a thin foil which itself does not need to have any carrying property, since it is supported over the whole area by the cell stack.

As the previous embodiments illustrate, for the property of the compensation layer, that under pressure it is free-flowing and thus has hydraulic properties, it is essentially a question of the point in time of the exertion of pressure, that is to say directly after assembly and after introduction of the pressure forces via the tension rods. Although it is indeed favorable if these hydraulic properties remain also over a longer period of time, practical trials have however shown that it is sufficient to compensate this compensation layer directly after assembly, thus after exerting the clamping forces by the tension rods. A later curing with this as a rule does no damage if a certain basic elasticity remains.

List of Reference Numerals

1—end-plate

2—recesses at the edge

3—recess, flat

4—central recess

5—compensation layer

6—metal plate

7—cylindrical projection

8—compensation layer

9—cured region

1. An end-plate assembly of an electrochemical cell of the polymer electrolyte membrane construction type, in particular of a cell stack, with tensioning [clamping] between two end-plates, with the following features:
there is provided an end-plate (1) consisting of plastic or metal, via which the pressure forces are introduced into the cell or the cell stack,
on that side of the end-plate (1) facing the cell there is provided an electrically conductive layer (6) which is connected to an electrical connection (7) accessible from the outside,
between the end-plate (1) and the electrically conductive layer (6) there is provided a compensation layer (5;8) which evens out the force introduction into the cell or the cell stack over the surface,
the compensation layer is formed by a substance which is free-flowing under pressure.

2. An end-plate assembly according to claim 1, wherein the compensation layer is formed by a paste or an adhesive film.

3. An end-plate assembly according to one of the preceding claims, wherein the compensation layer is formed by a curing silicone layer (8).

4. An end-plate assembly according to one of the preceding claims, wherein the electrically conductive layer is formed by a preferably surface-coated metal foil.

5. An end-plate assembly according to one of the preceding claims, wherein the metal foil at the side facing the cell is provided with an electrically conductive and corrosion-resistant layer preferably consisting of gold.

6. An end-plate assembly according to one of the preceding claims, wherein the electrically conductive layer (6) comprises a projection (7) which is lateral or passes through the end-plate (1) and which forms the electrical connection of the cell or cell stack.

7. An end-plate assembly according to one of the preceding claims, wherein the end-plate comprises an edge surrounding at least the compensation layer (8).

8. An end-plate assembly according to one of the preceding claims, wherein the end-plate (1) is formed as a plastic injection molding part and comprises edge-side recesses (2) for tension rods (2).

9. An end-plate assembly according to one of the preceding claims, wherein the compensation layer (8) on the edge-side is limited by a seal incorporated between the end-plate (1) and the electrically conductive layer (6).

10. A cell stack with at least two electrochemical cells of the polymer electrolyte membrane construction type which is clamped between two end-plates, and which comprises a pressure compensation layer, wherein the pressure compensation layer arranged between the cells is formed by a substance free-flowing under pressure.
